(19) United States
(12) Patent Application Publication
(10) Pub. No.: US 2025/0296491 A1
(43) Pub. Date: Sep. 25, 2025

(54) CLIP

(71) Applicant: NIFCO INC., Yokosuka-shi (JP)

(72) Inventors: Takanori OTAKE, Yokosuka-shi (JP); Hiroaki MORI, Yokosuka-shi (JP); Yukichi SATO, Yokosuka-shi (JP)

(21) Appl. No.: 19/059,267

(22) Filed: Feb. 21, 2025

(30) Foreign Application Priority Data
Mar. 21, 2024 (JP) 2024-044765

(51) Int. Cl. B60N 3/02

(52) U.S. Cl. CPC B60N 3/023

(57) ABSTRACT

A clip for attaching a vehicle interior component to a rectangular hole provided on a vehicle body panel includes a body to be attached to the vehicle interior component, and two or more engagement portions formed integrally with the body and configured to be pressed against the rectangular hole. The two or more engagement portions protrude on two sides of the body via a gap therebetween and are configured to be arranged in positions adjacent to at least a pair of left and right corners in two pairs of left and right corners of the rectangular hole. Each engagement portion includes a fall prevention claw and an engagement claw for clamping a hole edge of the rectangular hole at an upper end thereof.

### BACKGROUND OF THE INVENTION

### Field of the Invention

The present invention relates to a clip that is used in a vehicle field and that is particularly suitable in a case where vehicle interior components such as decorative components and functional components are attached to a vehicle body panel by pushing-in operation.

### Description of the Related Art

FIGS. 10(a) and 10(b) illustrate a clip disclosed in Patent Literature 1. FIG. 10(a) is a perspective view of a clip, and FIG. 10(b) is a sectional view illustrating the clip attached to an assist grip and engaged with a rectangular hole in a vehicle body panel. In a state where this clip 11 is attached to an assist grip 1 of a vehicle interior component, engagement portions 13 on both sides of the clip 11 are attached to a rectangular hole (fitting hole) 24 of a vehicle body panel 23 by pushing-in operation. Namely, the clip 11 includes a U-shaped body 12 and the engagement portions 13. The engagement portions 13 are bent from the end portions of both U-shaped wall portions 34 of the body 12 via bent portions 14 and are pressed against the rectangular hole 24.

The protruding end of each engagement portion 13 is provided with an engagement claw (retaining portion) 19 and a fall prevention claw (preventing portion) 21, which are capable of clamping the hole edge of the rectangular hole 24. In addition, the protruding end of each engagement portion 13 has engagement pieces 16 divided by two vertical slits 15 and disposed at right and left, and a stopper 17 disposed between the slits 15. The upper side of each engagement piece 16 is provided with an inclined portion 18 with its upper end being bent to the side of the wall portion 34, and the engagement claw 19 positioned on the base of the inclined portion 18 and protruded upward by cutting and raising. In addition, the upper end of the stopper 17 is provided with the fall prevention claw 21 protruding in a direction away from the wall portion 34.

The body 12 of the clip 11 is attached to the assist grip 1, as shown in FIG. 10(b), and then engaged against the rectangular hole 24 of the vehicle body panel by pushing-in operation. In this process, the clip 11 is inserted into the rectangular hole 24, and both engagement portions 13 are pressed against the hole edge of the rectangular hole 24. In addition, the clip 11 is attached to the panel 23 with the inclined portion 18 pressed against the hole edge on the back of the panel, as shown in FIG. 10(b), with the panel clamped from front and back by the fall prevention claw 21 and the engagement claw 19.
Patent Literature 1: Japanese Patent Application Laid-Open No. 2001-65524

Unfortunately, when used for the attachment structure of a vehicle interior component such as an assist grip, the clip described above can maintain attachment strength to the assist grip using a total of four engagement claws against excessive force in the direction of pulling away from the panel, but there is a risk of generating shifting or rattling due to excessive force in a rotational or prying direction. The cause of this is that, in particular, the clip has only one fall prevention claw between the engagement claws, making it difficult to increase clamping force between the engagement claws.

An object of the present invention is to solve the above problems, and to provide a clip that has excellent stability and engagement characteristics and that does not shift or rattle even if a large load or force is applied to the clip in a rotational or prying direction. Other objects will be apparent in the following description.

### SUMMARY OF THE INVENTION

An invention according to the first aspect, which is specified with reference to the accompanying drawings for achieving the above object, is a clip 4 for attaching a vehicle interior component 1, such as a decorative component and a functional component, to a rectangular hole 11 provided on a vehicle body panel 10, the clip 4 including: a body 40 that is attached to the vehicle interior component; and a plurality of engagement portions 44 formed integrally with the body 40 and pressed against the rectangular hole 11, in which, as the engagement portions, two or more engagement portions 44 protrude on both sides in a width direction of the body via gaps S and are disposed in positions adjacent to at least a pair of left and right corners among two pairs of left and right corners of the rectangular hole 11, to form a fall prevention claw 45 and an engagement claw 46 that are capable of clamping a hole edge of the rectangular hole 11 at upper ends.

In addition, the present invention is preferably embodied as follows.

(1) The two or more engagement portions are provided such that the fall prevention claw is close to a side of the body and the engagement claw is away from the side of the body further than the fall prevention claw (a second aspect).

(2) The body is substantially U-shaped and the engagement portions are provided on both sides in a width direction of both opposing end portions of the U-shaped body (a third aspect).

(3) The body and the engagement portions are integrally formed of a plate material, and the respective engagement portions are connected on both sides of a middle portion of the U-shaped body (a fourth aspect).

(4) The vehicle interior component is an assist grip switchable between a retracted position and a use position via a holding member, and the clip is assembled to a standing wall provided on the holding member (a fifth aspect).

In the invention according to the first aspect, in particular, the clip has the two or more engagement portions disposed in the left and right corners of the rectangular hole, and clamping force can be increased equally on left and right by the engagement claw and the fall prevention claw. These configurations make the clip less likely to rattle than the conventional products even if a large load is applied to a vehicle interior component in a rotational or prying direction, leading to excellent stability and engagement characteristics.

In the invention according to the second aspect, the two or more engagement portions have a structure in which the fall prevention claw is close to the side of the body and the engagement claw is away from the side of the body further than the fall prevention claw. Each engagement claw can thus be positioned close to the four corners of the rectangular hole in the vehicle body panel, as inferred from FIG. 4. As a result, with this structure of the engagement portion, the engagement position by a total of four engagement claws can be set close to the four corners of the rectangular hole in the vehicle body panel, and the hole edge of the rectangular hole and the engagement portion are thus hardly deformed even if a large external force is applied in a rotational or prying direction from the vehicle interior component.

In the invention according to the third aspect, the engagement portions are provided on both sides in the width direction of both opposing end portions of the U-shaped clip body. The operational effect described in the second aspect can thus be obtained more securely.

In the invention according to the fourth aspect, the clip body and the engagement portions are formed integrally with a plate material, which facilitates mass production even if the clip has the engagement portions, the fall prevention claws, and the engagement claws.

In the invention according to the fifth aspect, the clip of the present invention can be used instead of a conventional clip, and can provide an assist grip with a superior quality that prevents the clip from rattling or shifting even if a large load is applied to the clip in a prying direction, and can thus improve reliability and versatility.

### BRIEF DESCRIPTION OF THE DRAWINGS

FIGS. 1(a) and 1(b) illustrate an assist grip of an embodiment of the present invention, wherein FIG. 1(a) is a back view of the assist grip, and FIG. 1(b) is a front view viewed from a direction A.

FIG. 2(a) is a schematic view of the assist grip viewed from a panel side (not illustrated) in a retracted position of the grip body, and FIG. 2(b) is a schematic view of the assist grip viewed from above in a use position of the grip body.

FIG. 3 is a schematic exploded perspective view of the assist grip.

FIG. 4(a) is a schematic external view of the clip, and FIG. 4(b) is a schematic view illustrating a disposed position of the engagement portions, engagement claws, and fall prevention claws with respect to a rectangular hole of a vehicle body panel for attachment.

FIGS. 5(a) to 5(e) illustrate details of the clip, wherein FIG. 5(a) is a top view, FIG. 5(b) is a front view, FIG. 5(c) is a side view, FIG. 5(d) is a back view, and FIG. 5(e) is a bottom view.

FIG. 6(a) is a schematic cross-sectional view of an initial state of an attachment operation in which the grip is positioned to face a rectangular hole on a panel side in order to attach the assist grip to the vehicle body panel, and FIG. 6(b) is a schematic cross-sectional view of the grip body in a process of being pushed in the arrow direction.

FIG. 7(a) is a schematic cross-sectional view of the assist grip attached to the vehicle body panel in a B-B cross-section in FIG. 1(a), and FIG. 7(b) is an operational view of important components schematically illustrating the relationship between the rectangular hole in the vehicle body panel and the engagement portion of the clip.

FIGS. 8(a) and 8(b) illustrate a variation of the clip, wherein FIG. 8(a) is a schematic external view of the clip, and FIG. 8(b) is a schematic view illustrating a disposed position of the engagement portions, the engagement claws, and the fall prevention claws with respect to the rectangular hole of the vehicle body panel.

FIGS. 9(a) to 9(e) illustrate details of the clip of the variation, wherein FIG. 9(a) is a top view, FIG. 9(b) is a front view, FIG. 9(c) is a side view, FIG. 9(d) is a back view, and FIG. 9(e) is a bottom view.

FIGS. 10(a) and 10(b) show a clip illustrated in Patent Literature 1, wherein FIG. 10(a) illustrates FIG. 2 in Patent Literature 1, and FIG. 10(b) illustrates FIG. 10 in Patent Literature 1.

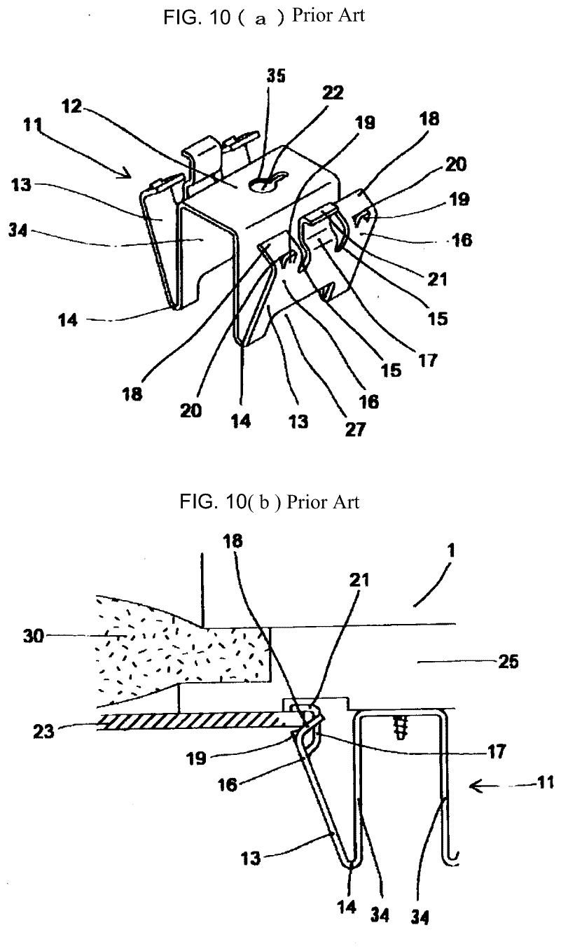

### DETAILED DESCRIPTION OF EMBODIMENTS

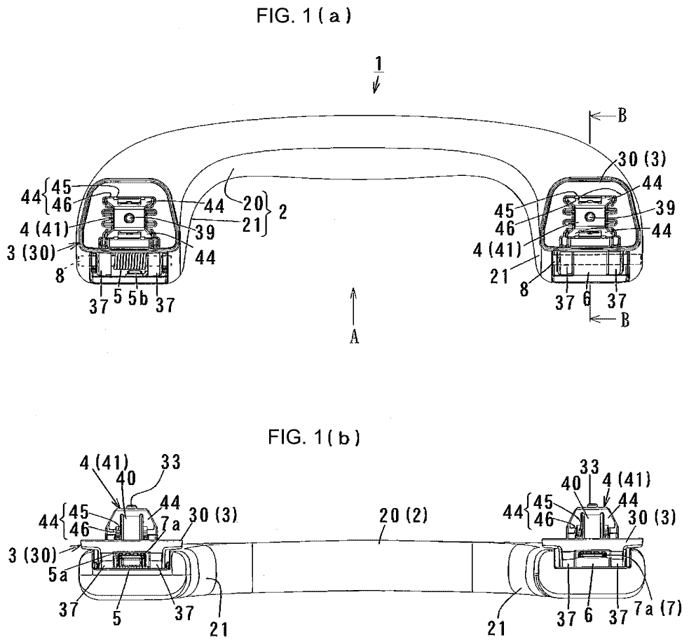

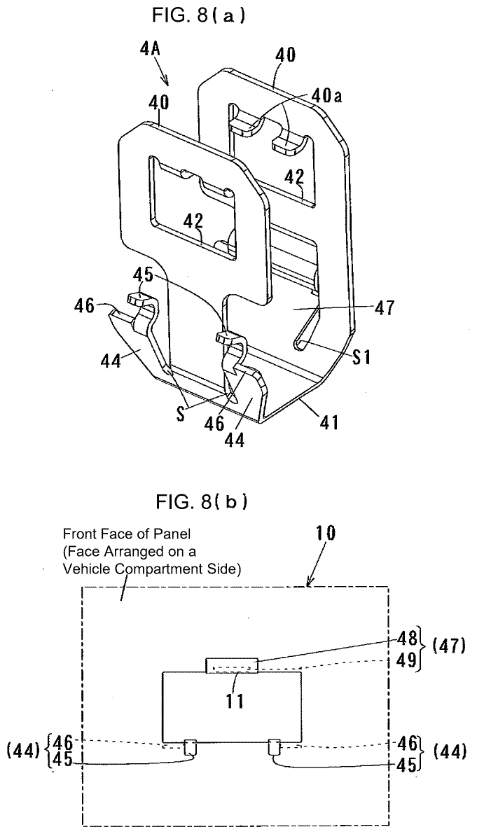

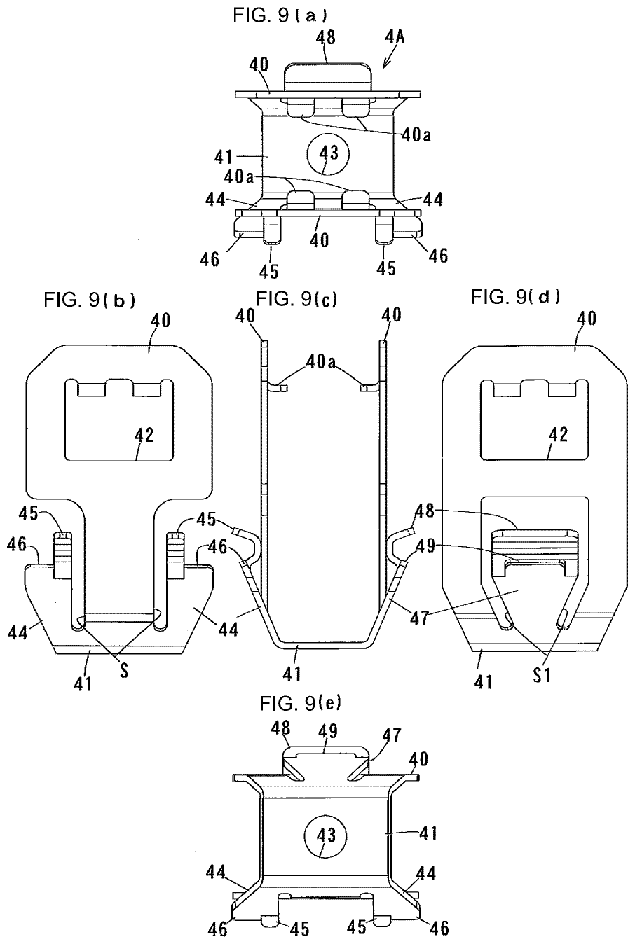

The present invention will now be described with reference to the accompanying drawings. This description clarifies an embodiment of the clip disclosed in FIGS. 1(a) to 7(b), and then mentions a variation of the clip disclosed in FIGS. 8(a) and 9(e). Each clip in the embodiment and the variation is an example of a configuration in which an assist grip is attached to a vehicle body panel by pushing-in operation as an example of a vehicle interior component.

(Clip in Embodiment) In FIGS. 1(a) to 7(b), an assist grip 1 is provided with a grip body 2 including a gripping portion 20 and curved end portions 21 on both sides, holding members 3 each being rotatably assembled to each end portion 21 via a shaft 8, clips 4 each being attached to each of the holding members 3 and engaged with each rectangular hole 11 in a vehicle body panel 10, a torsion coil spring 5 that biases the grip body 2 in a direction to a retracted position, a damper 6 that brakes the rotation speed of the grip body 2, and a cover 7 that attaches the clip 4 to the holding member 3. In the main components, the clip 4, which is a metal plate, may be resin or other material. The holding member 1, the grip body 2, the holding member 3, and the cover 7 are resin molded products, but any material other than resin is also acceptable.

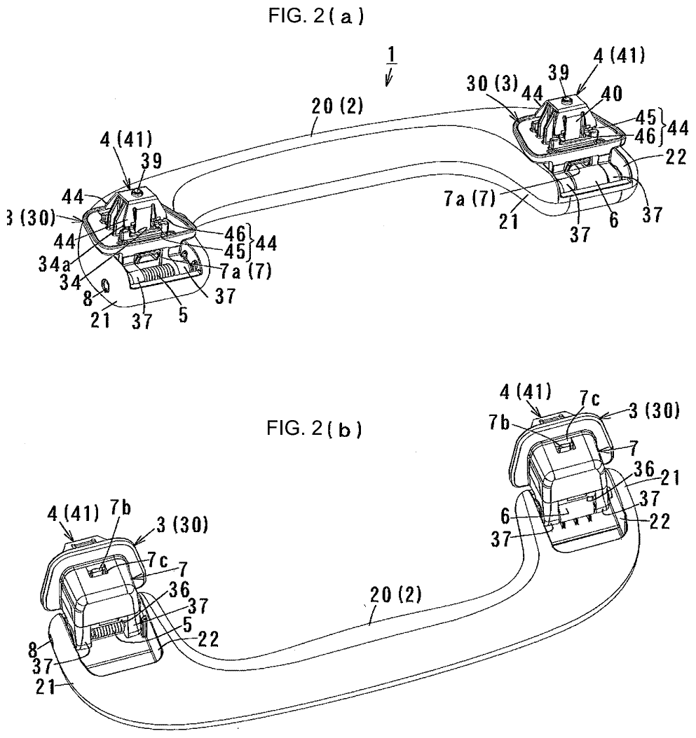

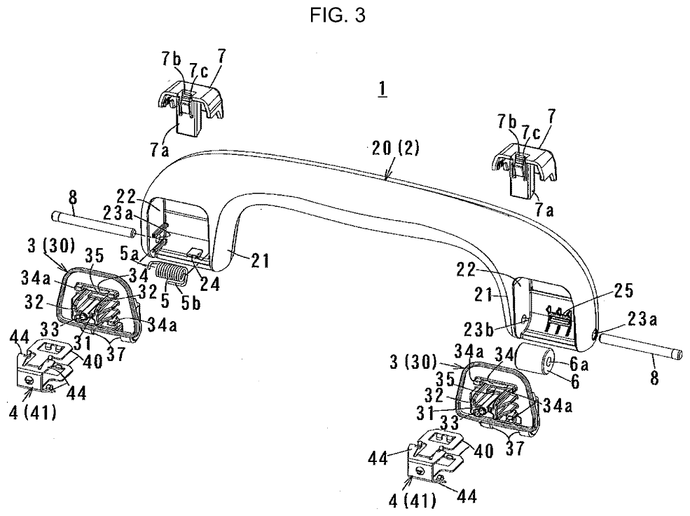

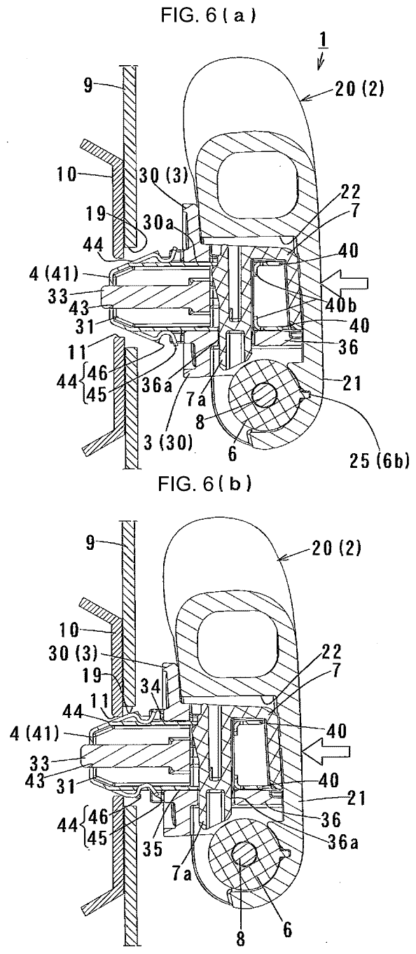

The grip body 2 has a substantially U-shaped middle portion, which is the gripping portion 20, and has recesses 22 formed on the back sides of the end portions 21 in the longitudinal direction. In each recess 22, the holding member 3 is rotatably disposed with the shaft 8 as a supporting point, and is switchable between the retracted position of the grip body 2 with the holding member 3 superposed on the back face of the end portion 21, as in FIG. 2(a), and the use position with the grip body 2 raised up at an angle of approximate 90 degrees from the end portion 21, as shown in FIG. 2(b). Shaft holes 23a and 23b are provided on opposite outer and inner faces of each recess 22 in the same axial line. The shaft hole 23a penetrates through the inside and outside and allows the shaft 8 to be inserted from the outside. The shaft hole 23b is recessed to receive an end of the shaft 8. In FIG. 3, the left-side recess 22 is provided with a hook portion 24 or the like for spring engagement, and the right-side recess 22 is provided with a stepped portion 25 (see FIG. 6(a)) that fits with a protrusion 6b on an outer cylinder of the damper 6.

The holding member 3 has a rectangular substrate 30 disposed approximately at a middle on the upper and lower portions. The upper side of the substrate 30 is provided with a standing wall 31 protruding at a right angle in the center and ribs 32 protruding on left and right sides of the standing wall 31, a shaft 33 protruding on the protruding end of the standing wall 31, insertion holes 35 formed on both sides of the standing wall 31 and penetrating downward between the ribs 32, a step 34, which is one level higher, protruding outside each insertion hole 35, and protrusions 34 protruding on both sides of the step 34. The lower side of the substrate 30 is provided with a support 36 protruding along the lower edge, as illustrated in FIGS. 6(a) and 6(b), a through hole 36a opening through a portion of the support 36, and left and right legs 37 (see FIG. 2) that protrude on the lower side of the support 36 and that have the coil spring 5 or the damper 6 between the legs.

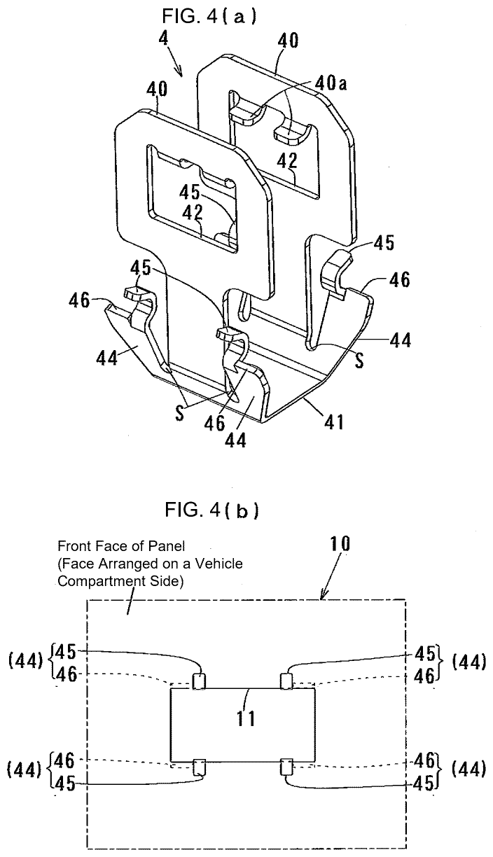

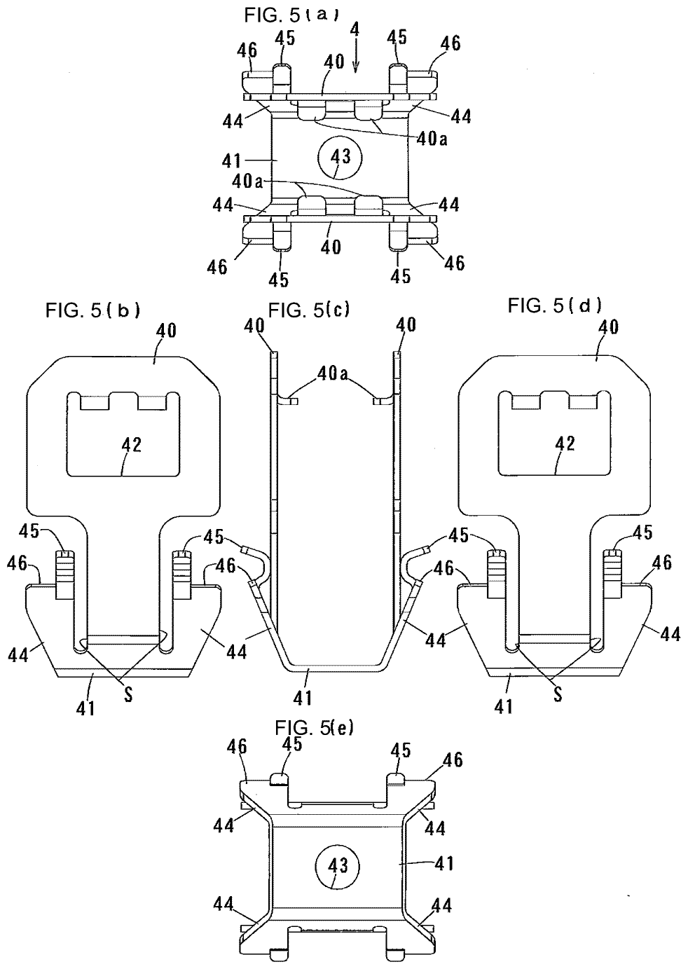

The clip 4 is obtained by press forming of a metal plate material, as illustrated in FIGS. 4(a) and 5(a)-5(e), and includes a substantially U-shaped body to be attached to the holding member 3, and a plurality of engagement portions 44 that is formed integrally with the body and pressed against the rectangular hole 11 of the vehicle body panel. The body includes both U-shaped opposing end portions 40 and a middle portion 41 connecting both end portions 40. The engagement portions 44 are provided on both sides of both end portions 40 in the width direction, i.e., at four positions. The upper half of both end portions 40 is wider than the lower half. The wider portions have rectangular insertion holes 42 through which a connecting portion 7a of the cover 7 described later passes, and pushing portions 40a protruding inward from the opposing upper edges of the insertion holes 42 and abutting a connecting shaft 7a of the cover 7. The middle portion 41 has a fitting hole 43, provided in the center, through which the shaft 33 of the holding member passes.

The engagement portions 44 protrude via gaps S from both sides of each end portion 40, and are provided so as to become wider from the bottom to the top. Each engagement portion 44 can be pressed against the rectangular hole 11 in the vehicle body panel. The respective engagement portions 44 are disposed in positions adjacent to the two sets of left and right corners that define the rectangular hole 11, each having a fall prevention claw 45 and an engagement claw 46 that are formed at the upper end and capable of clamping the hole edge of the rectangular hole 11. In addition, each engagement portion 44 is connected to each of both sides of the U-shaped middle portion 41, and is provided such that the fall prevention claw 45 is close to the corresponding side of the end portion 40 and the engagement claw 46 is away from the side of the end portion 40 further than the fall prevention claw 45.

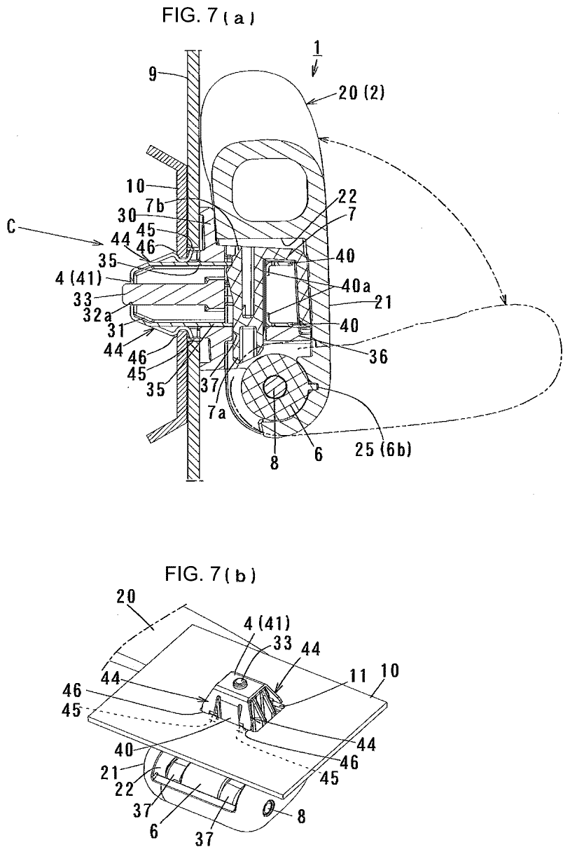

The fall prevention claw 45 and the engagement claw 46 are formed so as to have the following relationship with the rectangular hole 11. When the fall prevention claw 45 is pushed into the back face side of the panel 10 from inside the vehicle compartment with elastic displacement, as illustrated in FIG. 7(a), the tip end of the fall prevention claw is caught by the surface edge of the rectangular hole 11, preventing further pushing-in to the back side. On the other hand, the engagement claw 46 penetrates the rectangular hole 11 with elastic displacement, returns to its original state as soon as the claw has passed, and is thereby fixed to the back face of the panel 10 with prevention from pulling out, as shown in FIG. 7(a).

(Assembly) The clip 4 is assembled to the holding member 3 via the cover 7. In this operation, when the end portion 40 of the clip 4 is inserted into each of the corresponding insertion holes 35 of the holding member 3, the standing wall 31 is disposed inside each of end portions 40 and the shaft 33 is fitted into the fitting hole 43. From this state, the clip 4 is attached to the holding member 3 by the cover 7 with prevention from pulling out. Namely, as illustrated in FIG. 3, the cover 7 has the connecting shaft 7a protruding on its inner face, and an engagement piece 7b swingably provided on the upper end of the connecting shaft 7a via a gap 7c. When the connecting shaft 7a is inserted into the insertion hole 42 of one end portion 40, the through hole 36a of the support 36 described above, and the insertion hole 42 of the other end portion 40, the cover 7 is fixed to the holding member 3 by the engagement piece 7b being pressed against the corresponding inner side face of the insertion hole 42 with prevention from pulling out and by the pushing portions 40a being pressed against the connecting shaft 7a. To remove the cover 7, the cover 7 is pulled away from the holding member 3 with the engagement piece 7b being pressed toward the side of the gap 7c.

When the two holding members 3, each of which has the clip 4 and the cover 7 assembled, are assembled to the left and right recesses 22 of the grip body 2 using the coil spring 5 and the shaft 8 or using the damper 6 and the shaft 8, as illustrated in FIG. 3, the assist grip 1 is completed. Specifically, the holding member 3 to which the clip 4 and the cover 7 are assembled is disposed together with the coil spring 5 on the left-side recess 22, and is rotatably assembled via the shaft 8. The shaft 8 is press-fitted into one shaft hole 23a in the end portion 21, a shaft hole (not illustrated) in one leg 37, the inner portion of the coil spring 5, a shaft hole (not illustrated) in the other leg 37, and the other shaft hole 23b. The coil spring 5 is held around the axis of the shaft 5, the other end 5b is engaged with the hook portion 24 in the recess 22, and one end 5a is engaged with a corresponding portion of the holding member 3 with increasing biasing pressure. In this state, the shaft 8 is press-fitted and fixed in the shaft hole 23a and the like, and the grip body 2 is rotated to the retracted position by the biasing force of the coil spring 5, as illustrated in FIG. 2(a) and the like.

On the other hand, the holding member 3, to which the clip 4 and the cover 7 are assembled, is disposed together with the damper 6 on the right-side recess 22, and is rotatably assembled via the shaft 8. Also in this case, as inferred from FIGS. 2(a), 2(b) and 3, the shaft 8 is press-fitted into one shaft hole 23a in the end portion 21, a shaft hole (not illustrated) in the one leg 37, an inner portion 6a of the damper 6, a shaft hole (not illustrated) in the other leg 37, and the other shaft hole 23b. The damper 6 has a configuration in which inner and outer cylinders are rotated relative to each other with receiving a resistance of hydraulic oil. As illustrated in FIG. 6(b), the damper 6 is disposed between the legs 37 with the protrusion 6b on the side of the outer cylinder fitting into a fitting groove 25 in the recess 22, and the rotation of the outer cylinder is braked by the hydraulic oil filled between the inner cylinder and the outer cylinder in the process of rotating the grip body 2 from the retracted position to the use position and from the use position to the retracted position. When rotating, the grip body 2 is rotated while receiving a certain resistance due to the braking action of the damper 8 via the holding member 3. In this point, in particular, the grip body 2 is rotated by a human hand to the use position while resisting the biasing force of the coil spring 5, as illustrated in a one-dot diagonal line in FIG. 7(a), and is rotated again to the retracted position illustrated in a solid line by the biasing force accumulated in the coil spring 5 when the hand is released. At that time, in this structure, the grip body 2 is braked by the damper 6 and rotated slowly, which improves usability and a sense of luxury.

### (Operation) the Assist Grip 1 has the Following Advantages.

(1) In a basic operation, the grip body 2 is rotated by a human hand to the use position while resisting the biasing force of the coil spring 5, as illustrated in the one-dot diagonal line in FIG. 7(a), and is rotated again to the retracted position illustrated in the solid line by the biasing force accumulated in the coil spring 5 when the hand is released. In this switching operation, the grip body 2 is braked by the damper 6 and rotated slowly, which provides better usability and a sense of luxury. Of course, the grip body 2 in the retracted position is pressed against the vehicle body panel 10 or a trim 9 covering the surface by the biasing force of the coil spring 5, and there is thus no risk of rattling even if driving vibration is applied.

(2) As a key operation, in the same manner as conventional grips, the grip body 2 is attached in a state where the clip 4 attached to the holding member 3 is engaged with the rectangular hole 11 of the vehicle body panel by pushing-in operation. In this embodiment, the clip 4 has the engagement portions 44 provided on a total of four positions that protrude on both sides in the width direction of the end portions 40 of the body via the gaps S, as illustrated in FIG. 7(b). These four engagement portions 4 are disposed in positions adjacent to the two sets of the left and right corners of the rectangular hole 11, as illustrated in FIG. 4(b) and FIG. 7(b). Furthermore, each engagement portion 44 forms the fall prevention claw 45 and the engagement claw 46, which are capable of clamping the hole edge of the rectangular hole 11, at the upper end. In this structure, the clip 4 has four engagement portions 44 positioned corresponding to the left and right corners of the rectangular hole 11, and clamping force can be increased equally on the left and right sides by the engagement claw 46 and the fall prevention claw 45. These configurations make the assist grip 1 less likely to rattle than conventional products even if a large load is applied to the assist body 2 in a prying direction, leading to excellent stability and engagement characteristics.

(3) The engagement portion 44 has the fall prevention claw 45 close to the side of the end portion 40 and has the engagement claw 46 away from the side of the end portion 40 further than the fall prevention claw 45. The engagement positions of the engagement claws 46 can thus be positioned close to the four corners of the rectangular hole 11 in the vehicle body panel 10, as inferred from FIG. 4(b). Therefore, in this structure, the engagement positions, by a total of four engagement claws 46, of the engagement portions 44 can be set close to the four corners of the rectangular hole 11, thus it is also excellent in that the hole edge of the rectangular hole 11 and the engagement portion 44 are hardly deformed even if a large external force is applied in a rotational or prying direction from the grip body 2.

(4) In this clip 4, for example, both end portions 40 of the U-shape of the clip body, the four engagement portions 44, as well as the fall prevention claw 45 and the engagement claw 46 are easily formed from a plate material by pressing, which is excellent for mass production.

(Variation) FIGS. 8(a) to 9(e) illustrate a variation of the clip described above corresponding to FIGS. 4(a) to 5(e). In the description of this variation, the same or similar terms as in the embodiment described above are marked with the same symbol, and duplicate descriptions are omitted as much as possible.

A clip 4A of the variation has one less engagement portions than the above-described clip 4 does, with a total of three positions. Namely, the engagement portions of the clip 4A include two engagement portions 44 provided on both sides of one end portion 40 in a plate width direction and one engagement portion 47 defined in the approximate center of the other end portion 40 via gaps S1, among both opposing end portions 40 of the U-shape. At the tip end of the engagement portion 47, a fall prevention claw 48 and an engagement claw 49 are integrally provided.

In this variation, there are a total of three engagement portions 44 and 47, and the two engagement portions 44 can set the engagement positions of the engagement claws 46 close to the two corners of the rectangular hole 11 in the vehicle body panel 10. Although this configuration is slightly inferior to the first embodiment, unintentional rattling and shifting can be prevented even if a large external force is applied from the grip body 2 in a rotational or prying direction.

The clip of the present invention only needs to include the configuration specified in claims, and details can be further developed with reference to the embodiment and variation. As an example, although the assist grip in the embodiment is attached to the vehicle body panel via the trim, a configuration in which the assist grip is attached via a spacer or the like instead of the trim is also acceptable. The vehicle interior component of the present invention is not limited to an assist grip, and can also be a functional component such as a hook and a display, various decorative components, or similar components.

### REFERENCE SIGNS LIST

1 Assist grip (vehicle interior component)
2 Grip body
3 Holding member
4, 4A Clip
7 Cover
8 Shaft
9 Trim
10 Vehicle body panel
11 Rectangular hole
20 Gripping portion
21 End portion in longitudinal direction
22 Recess
30 Substrate
31 Protruding wall (protruding wall portion)
37 Leg
40 End portion (body)
41 Middle portion (body)
43 Fall prevention claw
44 Engagement portion
45 Fall prevention claw
46 Engagement claw
47 Engagement portion
48 Fall prevention claw
49 Engagement claw
S, S1 Gap

What is claimed is:

1. A clip for attaching a vehicle interior component to a rectangular hole provided in a vehicle body panel, comprising:
a body to be attached to the vehicle interior component; and
two or more engagement portions formed integrally with the body and configured to be pressed against the rectangular hole,
wherein the two or more engagement portions protrude on two sides of the body via a gap therebetween and are configured to be arranged in positions adjacent to at least a pair of left and right corners in two pairs of left and right corners of the rectangular hole, each engagement portion having a fall prevention claw and an engagement claw for clamping a hole edge of the rectangular hole at an upper end thereof.

2. The clip according to claim 1, wherein the fall prevention claw is arranged close to a side of the body, and the engagement claw is arranged at a position away from the side of the body further than the fall prevention claw.

3. The clip according to claim 1, wherein the body is substantially U-shaped to form a U-shaped body, and the engagement portions are provided on two sides in a width direction of opposing end portions of the U-shaped body.

4. The clip according to claim 3, wherein the body and the engagement portions are integrally formed of a plate, and the respective engagement portions are connected to two sides of a middle portion of the U-shaped body.

5. A combination comprising: a clip according to claim 1, and an assist grip as the vehicle interior component switchable between a retracted position and a use position via a holding member, the clip being assembled to a standing wall provided on the holding member.
